(19) United States
(12) Patent Application Publication
(10) Pub. No.: US 2013/0249373 A1
(43) Pub. Date: Sep. 26, 2013

(54) ADJUSTABLE HINGE ASSEMBLY FOR A DOMESTIC REFRIGERATOR

(71) Applicants: ERIC D. LIVELY, Eberfeld, IN (US); JULIE A. MANN, Haubstadt (IN); DARYL LEE REUTER, Evansville, IN (US)

(72) Inventors: ERIC D. LIVELY, Eberfeld, IN (US); JULIE A. MANN, Haubstadt (IN); DARYL LEE REUTER, Evansville, IN (US)

(73) Assignee: WHIRLPOOL CORPORATION, BENTON HARBOR, MI (US)

(21) Appl. No.: 13/428,067

(22) Filed: Mar. 23, 2012

(51) Int. Cl. E05D 7/04; E05D 11/10; E05D 15/58; F25D 23/02

(52) U.S. Cl. 312/405; 49/260

(57) ABSTRACT

A domestic refrigerator includes a door operable to pivot about an axis of rotation, a cam plate coupled to the door that includes a first cam surface, and a coupler body having a second cam surface engaged with the first cam surface. The coupler body has an inner wall that defines an aperture and includes a pair of substantially planar surfaces. A hinge pin defines the axis of rotation and has an upper end positioned in the aperture of the coupler body. The upper end includes a pair of substantially planar surfaces engaged with the pair of substantially planar surfaces of the coupler body to prevent rotation of the coupler body about the axis of rotation.

### CROSS-REFERENCE TO RELATED U.S. PATENT APPLICATIONS

Cross-reference is made to co-pending U.S. Utility patent application Ser. No. 13/428,031 entitled “HINGE ASSEMBLIES FOR A DOMESTIC REFRIGERATOR,” which was filed on Mar. 23, 2012 (SUB-01114-US-NP), which is assigned to the same assignee as the present application and which is hereby incorporated by reference.

### TECHNICAL FIELD

The present disclosure relates generally to a domestic refrigerator and more particularly to a hinge assembly for a door of a domestic refrigerator.

### BACKGROUND

A domestic refrigerator is a device used to store food items in a home at preset temperatures. A domestic refrigerator typically includes one or more temperature-controlled compartments into which food items may be placed to preserve the food items for later consumption. A domestic refrigerator also typically includes a door that permits user access to the temperature-controlled compartment defined in the refrigerator cabinet. The door may be mounted to the cabinet via a hinge assembly.

### SUMMARY

According to one aspect of the disclosure, a domestic refrigerator is disclosed. The domestic refrigerator includes a cabinet having a temperature-controlled compartment defined therein, and a door positioned at a front of the cabinet. The door is operable to pivot about an axis of rotation between a closed position in which user access to the temperature-controlled compartment is prevented and an open position in which user access to the temperature-controlled compartment is permitted. The domestic refrigerator also includes a cam plate coupled to the door, and the cam plate includes a first cam surface. The domestic refrigerator has a coupler body including a second cam surface engaged with the first cam surface, a lower surface having an opening defined therein, and an inner wall extending upwardly from the opening to define an aperture in the coupler body. A hinge pin defines the axis of rotation and includes a cylindrical shaft having an upper end positioned in the aperture of the coupler body and a plurality of longitudinal slots defined in the cylindrical shaft. A plurality of splines extend inwardly from the inner wall of the coupler body, and each spline is received in a corresponding longitudinal slot of the hinge pin to prevent rotation of the coupler body about the axis of rotation.

In some embodiments, the domestic refrigerator may further include an adjustment mechanism configured to move the door vertically relative to the cabinet between a first position and a second position. In some embodiments, the cylindrical shaft of the hinge pin may have a passageway defined therein, and the adjustment mechanism may include a threaded rod positioned in the passageway of the cylindrical shaft. The threaded rod may have an upper end engaged with the coupler body.

In some embodiments, the inner wall of the coupler body may extend upwardly from the opening to an inner surface, and the coupler body may include a central shaft that extends downwardly from the inner surface. The central shaft may have a lower end positioned in the passageway of the cylindrical shaft and engaged with the upper end of the threaded rod.

Additionally, in some embodiments, the threaded rod may have a plurality of outer threads, and the cylindrical shaft of the hinge pin may include an inner wall that defines the passageway therethrough. The inner wall of the cylindrical shaft may have a plurality of inner threads defined therein that are engaged with the outer threads of the threaded rod such that rotation of the threaded rod in a first direction may cause upward movement of the coupler body and the door, and rotation of the threaded rod in a second direction may cause downward movement of the coupler body and the door.

In some embodiments, the adjustment mechanism may include a stop configured to prevent upward movement of the threaded rod beyond a predetermined position corresponding to the second position of the door. In some embodiments, the stop may include a substantially smooth section of the inner wall of the cylindrical shaft. The substantially smooth section may be positioned above the plurality of inner threads. In some embodiments, a distance may be defined between the first position and the second position of the door. The distance may be approximately three millimeters.

In some embodiments, the domestic refrigerator may further include a bushing has the cam plate. The door may include a frame and a front panel secured to the frame, and the bushing may be coupled to the frame and positioned behind the front panel. Additionally, in some embodiments, the bushing may include a bottom surface having an opening defined therein, an inner wall extending upwardly from the opening to an inner surface including the first cam surface, and an aperture defined by the inner wall and the inner surface. The coupler body may have an upper end positioned in the aperture of the bushing. In some embodiments, the plurality of splines may include six splines extending from the inner wall of the coupler body.

According to another aspect, a domestic refrigerator includes a cabinet having a temperature-controlled compartment defined therein, and a door operable to pivot about an axis of rotation between a closed position in which user access to the temperature-controlled compartment is prevented and an open position in which user access to the temperature-controlled compartment is permitted. The domestic refrigerator also includes a hinge assembly including a hinge pin defining the axis of rotation and an adjustment mechanism configured to move the door vertically between a first position and a second position. The adjustment mechanism includes a threaded rod positioned in a passageway defined in the hinge pin, and a stop positioned in the passageway defined in the hinge pin. The threaded rod is configured to rotate in a first direction to cause upward movement of the door and a second direction to cause downward movement of the door. The stop is configured to prevent upward movement of the threaded rod beyond a predetermined position corresponding to the second position of the door.

In some embodiments, the hinge assembly may include a bushing secured to the door, and a coupler body coupled to the hinge pin. The bushing may include a first cam surface, and the coupler body may include a second cam surface engaged with the first cam surface. In some embodiments, the coupler body may include a lower surface positioned opposite the second cam surface. The lower surface may have an opening defined therein and an inner wall extending upwardly from the opening to an inner surface. The inner wall and the inner surface may define an aperture in the coupler body, and an upper end of the hinge pin may be positioned in the aperture defined in the coupler body.

Additionally, in some embodiments, the coupler body may include a central shaft that extends downwardly from the inner surface. The central shaft may have a lower end positioned in the passageway of the hinge pin and engaged with an upper end of the threaded rod. In some embodiments, the hinge pin may include a longitudinal slot defined in an outer surface thereof, and the coupler body may include a spline extending from the inner wall thereof. The spline may be received in the longitudinal slot of the hinge pin.

In some embodiments, the longitudinal slot may include at least six longitudinal slots, and the spline may include at least six splines extending from the inner wall of the coupler body. Each of the splines may be received in a corresponding longitudinal slot of the hinge pin.

In some embodiments, the domestic refrigerator may further include a first bracket secured to the door, and the first bracket may include a first flange coupled to the door and a second flange extending downwardly from the first flange. The domestic refrigerator may also include a second bracket including a mounting plate having the hinge pin secured thereto, and a side wall extending upwardly from an upper surface of the mounting plate. The second flange may be engaged with the side wall of the second bracket when the door is in the open position.

According to another aspect, a domestic refrigerator includes a cabinet having a temperature-controlled compartment defined therein, a pair of doors positioned at a front of the cabinet, and a pair of cam plates. Each cam plate is secured to one of the pair of doors and includes a lower cam surface. The domestic refrigerator also includes a pair of coupler bodies, and each coupler body has an upper cam surface configured to engage with the lower cam surface of one of the pair of doors, and an aperture defined therein. The domestic refrigerator includes a first hinge pin and a second hinge pin. The first hinge pin has a plurality of longitudinal slots defined in an outer surface thereof, and an upper end positioned in a first coupler body of the pair of coupler bodies. The second hinge pin has a plurality of longitudinal slots defined in an outer surface thereof, and an upper end positioned in a second coupler body of the pair of coupler bodies. The first coupler body includes a plurality of splines that are received in the plurality of longitudinal slots of the first hinge pin, and the second coupler body includes a plurality of splines that are received in the plurality of longitudinal slots of the second hinge pin.

In some embodiments, the domestic refrigerator may further include a threaded rod engaged with the first coupler body. The first hinge pin may have an inner wall extending between an upper opening and a lower opening to define a passageway therethrough. The inner wall may have a plurality of threads defined therein engaged with the threaded rod such that rotation of the threaded rod in a first direction may cause upward movement of the coupler body and a first door of the pair of doors, and rotation of the threaded rod in a second direction may cause downward movement of the coupler body and the first door. The second hinge pin may have a substantially smooth inner wall extending between an upper opening and a lower opening to define a passageway therethrough.

According to another aspect, the domestic refrigerator includes a cabinet having a temperature-controlled compartment defined therein, and a door operable to pivot about an axis of rotation between a closed position in which user access to the temperature-controlled compartment is prevented and an open position in which user access to the temperature-controlled compartment is permitted. The domestic refrigerator also includes a cam plate coupled to the door that includes a first cam surface, and a coupler body having a second cam surface engaged with the first cam surface, a lower surface positioned opposite the second cam surface, the lower surface having an opening defined therein, and an inner wall extending upwardly from the opening to define an aperture in the coupler body. A hinge pin defines the axis of rotation. The hinge pin has an upper end positioned in the aperture of the coupler body, and the upper end includes a pair of substantially planar surfaces and a pair of convex surfaces connecting the pair of substantially planar surfaces. The inner wall of the coupler body has a pair of substantially planar surfaces engaged with the pair of substantially planar surfaces of the hinge pin to prevent rotation of the coupler body about the axis of rotation.

In some embodiments, the hinge pin may have a passageway defined therein, the inner wall of the coupler body may extend upwardly from the opening to an inner surface, and the coupler body may include a central shaft that extends downwardly from the inner surface. The central shaft may have a lower end positioned in the passageway of the hinge pin. In some embodiments, the domestic refrigerator may further include an adjustment mechanism configured to move the door vertically between a first position and a second position relative to the cabinet.

Additionally, in some embodiments, the adjustment mechanism may include a threaded rod positioned in the passageway of the hinge pin. The threaded rod may have an upper end engaged with the lower end of the central shaft of the coupler body. In some embodiments, the threaded rod may have a plurality of outer threads, and the hinge pin may include an inner wall that defines the passageway therethrough. The inner wall may have a plurality of inner threads defined therein that are engaged with the outer threads of the threaded rod such that rotation of the threaded rod in a first direction may cause upward movement of the coupler body and the door, and rotation of the threaded rod in a second direction may cause downward movement of the coupler body and the door.

According to another aspect, the domestic refrigerator includes a door operable to pivot about an axis of rotation, a cam plate coupled to the door that includes a first cam surface, and a coupler body. The coupler body has a second cam surface engaged with the first cam surface, a lower surface having an opening defined therein, and an inner wall extending upwardly from the opening to define an aperture in the coupler body. The inner wall includes a pair of substantially planar surfaces. A hinge pin defines the axis of rotation. The hinge pin has an upper end positioned in the aperture of the coupler body. The upper end includes a pair of substantially planar surfaces engaged with the pair of substantially planar surfaces of the coupler body to prevent rotation of the coupler body about the axis of rotation. The domestic refrigerator also includes a threaded rod positioned in a passageway defined in the hinge pin and engaged with the coupler body. The threaded rod is configured to rotate in a first direction to cause upward movement of the door and a second direction to cause downward movement of the door.

In some embodiments, the inner wall of the coupler body may extend upwardly from the opening to an inner surface. The inner wall and the inner surface may define the aperture in the coupler body, and the coupler body may include a central shaft that extends downwardly from the inner surface. The central shaft may have a lower end positioned in the passageway of the hinge pin and engaged with an upper end of the threaded rod.

In some embodiments, the domestic refrigerator may include a stop positioned in the passageway defined in the hinge pin. The stop may be configured to prevent upward movement of the threaded rod beyond a predetermined position.

In some embodiments, the upper end of the hinge pin may include a pair of convex surfaces that connect the pair of substantially planar surfaces of the hinge pin, and the coupler body may include a plurality of ribs extending inwardly from the inner wall. The plurality of ribs may bee engaged with the pair of convex surfaces of the hinge pin.

In some embodiments, the domestic refrigerator may include a bushing secured to the door. The bushing may include a bottom surface having an opening defined therein, an inner wall extending upwardly from the opening to an inner surface that includes the first cam surface, and the aperture may be defined by the inner wall and the inner surface. The coupler body may have an upper end positioned in the aperture of the bushing. The upper end of the coupler body may include the second cam surface.

According to another aspect, a domestic refrigerator includes a cabinet having a temperature-controlled compartment defined therein, and a door operable to pivot about an axis of rotation between a closed position in which user access to the temperature-controlled compartment is prevented and an open position in which user access to the temperature-controlled compartment is permitted. The domestic refrigerator also includes a bushing secured to the door and a coupler body. The bushing has an aperture defined therein, and a first cam surface positioned in the aperture. The coupler body has an upper end positioned in the aperture of the bushing, and the upper end includes a second cam surface engaged with the first cam surface. The coupler body also has a lower surface having an opening defined therein, and an inner wall extending upwardly from the opening to define an aperture in the coupler body. The inner wall includes a pair of substantially planar surfaces. A hinge pin defines the axis of rotation. The hinge pin has an upper end positioned in the aperture of the coupler body, the upper end including a pair of substantially planar surfaces engaged with the pair of substantially planar surfaces of the coupler body to prevent rotation of the coupler body about the axis of rotation.

In some embodiments, the inner wall of the coupler body may extend upwardly from the opening to an inner surface. The inner wall and the inner surface may define the aperture in the coupler body, and the coupler body may include a central shaft that extends downwardly from the inner surface. The central shaft may have a lower end positioned in a passageway defined in the hinge pin.

In some embodiments, the domestic refrigerator may further include an adjustment mechanism configured to move the door vertically between a first position and a second position relative to the cabinet. Additionally, in some embodiments, the domestic refrigerator may include a threaded rod positioned in the passageway defined in the hinge pin and engaged with the lower end of the coupler body. The threaded rod may be configured to rotate in a first direction to cause upward movement of the door and a second direction to cause downward movement of the door.

### BRIEF DESCRIPTION OF THE DRAWINGS

The detailed description particularly refers to the following figures, in which:

FIG. 1 is a front elevation view of a domestic refrigerator;

FIG. 2 is an exploded, cross-sectional view of a right-hand door and one embodiment of an adjustable hinge assembly of the refrigerator of FIG. 1;

FIG. 3 is a rear perspective view of the adjustable hinge assembly of FIG. 2;

FIG. 4 is a perspective view of a hinge pin of the adjustable hinge assembly of FIG. 2;

FIG. 5 is a bottom perspective view of a coupler body of the adjustable hinge assembly of FIG. 2;

FIG. 6 is a cross-sectional side elevation view of the refrigerator of FIG. 1 showing the right-hand door in one vertical position relative to the refrigerator cabinet;

FIG. 7 is a view similar to FIG. 6 showing the right-hand door in another vertical position relative to the refrigerator cabinet;

FIG. 8 is a cross-sectional top plan view of the refrigerator of FIG. 1 with adjustable hinge assembly of FIG. 2;

FIG. 9 is an exploded, cross-sectional view of the left-hand door and one embodiment of a fixed hinge assembly of the refrigerator of FIG. 1;

FIG. 10 is a cross-sectional side elevation view of the refrigerator of FIG. 1 showing the left-hand door in one vertical position relative to the refrigerator cabinet;

FIG. 11 is an exploded, cross-sectional view of a right-hand door and another embodiment of an adjustable hinge assembly of the refrigerator of FIG. 1;

FIG. 12 is a perspective view of a hinge pin of the adjustable hinge assembly of FIG. 11;

FIG. 13 is a bottom perspective view of a coupler body of the adjustable hinge assembly of FIG. 11; and

FIG. 14 is a cross-sectional top plan view of the refrigerator of FIG. 1 with adjustable hinge assembly of FIG. 11.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

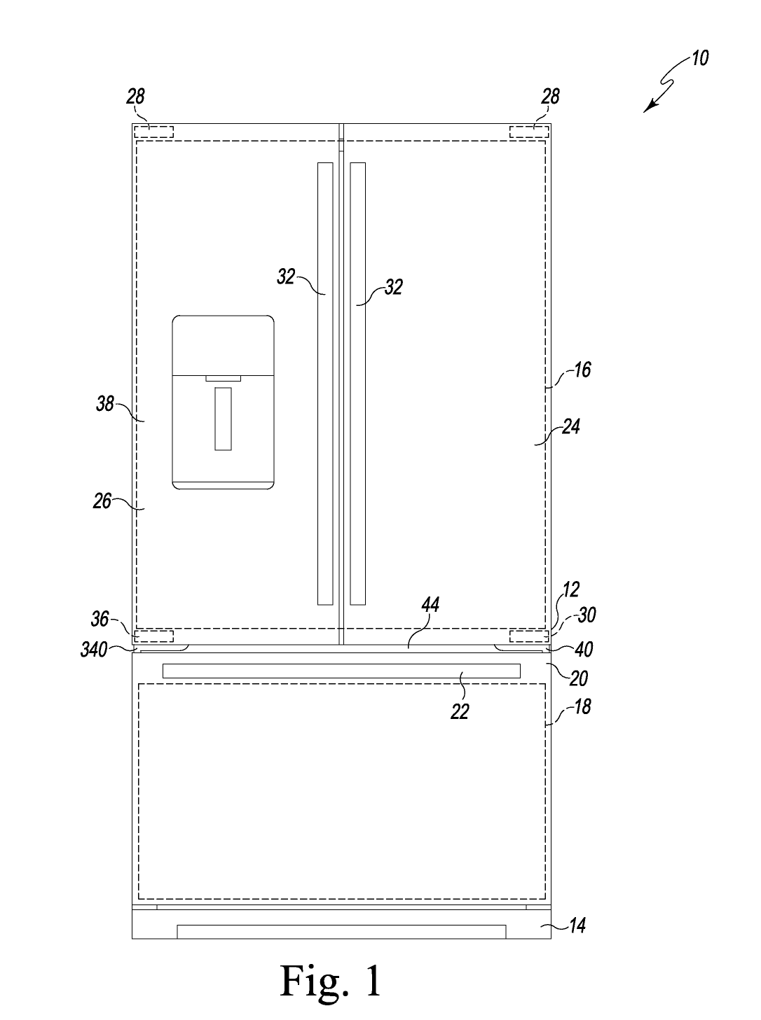

Referring to FIG. 1, a home appliance is shown as a domestic refrigerator appliance 10 (hereinafter refrigerator 10). The refrigerator 10 includes a cabinet 12 and a lower frame 14 that supports the cabinet 12. The refrigerator cabinet 12 defines a temperature-controlled, refrigerated compartment 16 into which a user may place and store food items such as milk, cheese, produce, etcetera. The refrigerated compartment 16 is operable to maintain stored food items at a predefined temperature.

As shown in FIG. 1, the refrigerator cabinet 12 defines a temperature-controlled freezer compartment 18, which is also operable to maintain food items stored therein at a certain temperature. The refrigerator 10 includes a drawer 20 that permits user access to the freezer compartment 18 such that food items may be placed in and retrieved from shelves and drawers positioned therein. When the drawer 20 is in the closed position shown in FIG. 1, user access to the freezer compartment 18 is prevented. A handle 22 is located on the drawer 20, and the user may use the handle 22 to pull the drawer 20 open. It will be appreciated that in other embodiments the freezer compartment may be positioned above or side-by-side with the refrigerated compartment 16, either as a free standing refrigerator or a built-in refrigerator. It will be further appreciated that in other embodiments the refrigerator 10 may not have a freezer compartment.

The refrigerator 10 includes a right-hand door 24 and a left-hand door 26 that permit user access to the refrigerated compartment 16 such that food items may be placed in and retrieved from the refrigerator 10. The right-hand door 24 is hinged to the front of the refrigerator cabinet 12 via an upper hinge assembly 28 and a lower hinge assembly 30. A handle 32 is located on a front panel 34 of the door 24, and the user may use the handle 32 to pull the right-hand door 24 open. The left-hand door 26 is hinged to the front of the refrigerator cabinet 12 via another upper hinge assembly 28 and a lower hinge assembly 36. Another handle 32 is located on a front panel 38 of the door 26, and the user may use that handle 32 to pull the left-hand door 26 open. As described in greater detail below, the lower hinge assembly 30 of the right-hand door 24 is operable to adjust the closed vertical position of the door 24 relative to the refrigerator cabinet 12. In the illustrative embodiment, the lower hinge assembly 36 of the left-hand door 26 is not adjustable and the closed vertical position of the door 26 is fixed.

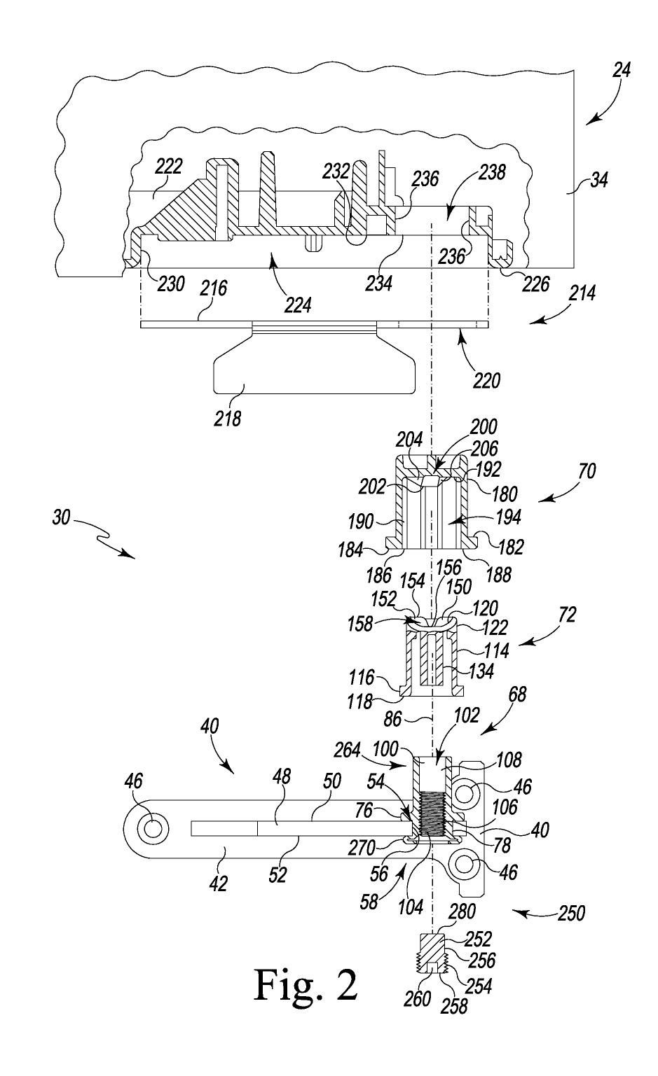

Referring now to FIG. 2, the lower hinge assembly 30 of the right-hand door 24 is configured to be secured to a hinge bracket 40. The hinge bracket 40 is formed from a metallic material, such as, for example, steel, and is sized to support the weight of the right-hand door 24. The hinge bracket 40 includes a vertical flange 42 and a mounting plate 48 that extends horizontally from the flange 42. The vertical flange 42 is configured to be attached to a front wall 44 of the cabinet 12 via a plurality of bolts (not shown), which extend through holes 46 formed in the flange 42 to engage the cabinet 12.

The mounting plate 48 of the hinge bracket 40 extends outwardly from the cabinet 12 when the bracket 40 is secured to the cabinet 12. The mounting plate 48 has an upper surface 50 and a lower surface 52 positioned opposite the upper surface 50. An opening 54 is defined in the upper surface 50 of the mounting plate 48, and an inner wall 56 extends downwardly from the opening 54 to define a bore 58 through the mounting plate 48. In the illustrative embodiment, the opening 54 is circular, and the bore 58 is substantially cylindrical. It should be appreciated that in other embodiments the opening may be oblong, square, or other geometric shapes.

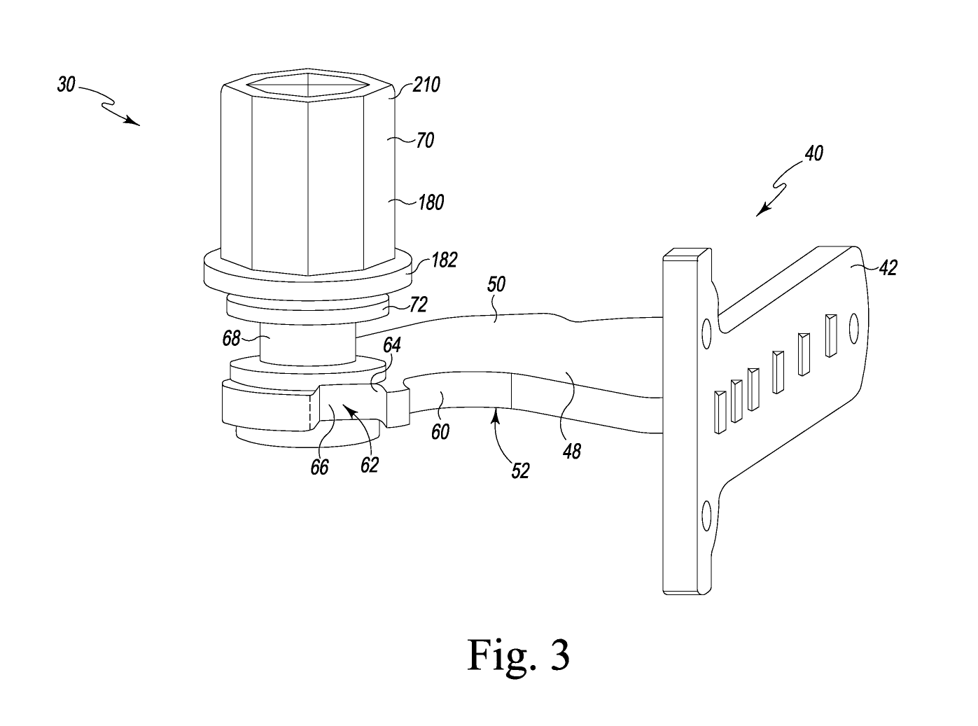

As shown in FIG. 3, the mounting plate 48 includes a side wall 60 that extends between the surfaces 50, 52. The side wall 60 defines a pocket 62 positioned adjacent to the lower hinge assembly 30. The mounting plate 48 also includes a flange 64 that extends upwardly from the upper surface 50. The flange 64 has a side wall 66 that is aligned with side wall 60, and the walls 60, 66 cooperate to act as a stop for the right-hand door 24, as described in greater detail below.

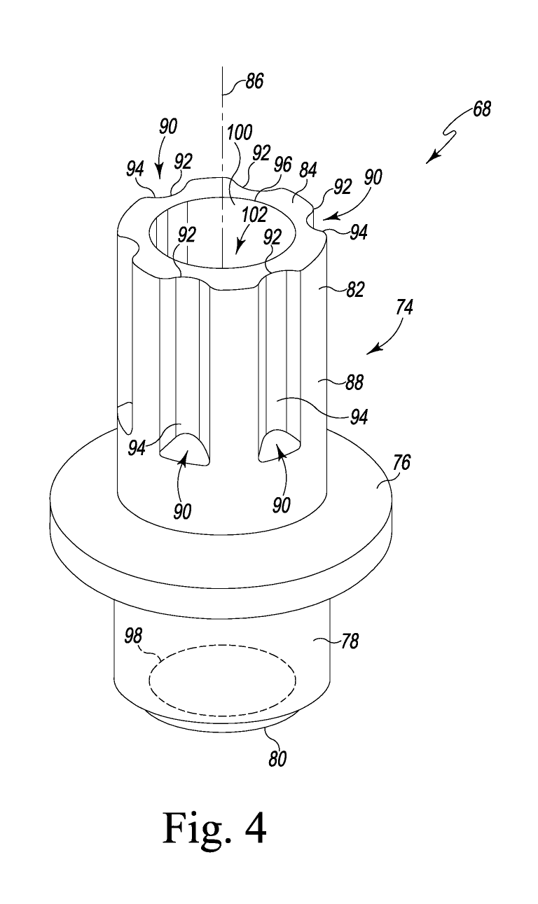

The lower hinge assembly 30 of the right-hand door 24 includes a hinge pin 68 configured to be secured to the hinge bracket 40, a bushing 70 configured to be secured to the right-hand door 24, and a coupler body 72 positioned between the hinge pin 68 and the bushing 70. As shown in FIG. 4, the hinge pin 68 has a body 74 and a circular flange 76 that extends outwardly from the body 74. The body 74 has a tail 78 that extends downwardly from the circular flange 76 to a lower end 80. The tail 78 has a cross-sectional geometry that is shaped to match the bore 58 of the mounting plate 48. In the illustrative embodiment, the tail 78 is cylindrical and has an outer diameter that is sized such that the tail 78 may be received in the bore 58.

The body 74 of the hinge pin 68 includes a cylindrical shaft 82, which extends upwardly from the circular flange 76 to an upper end 84. The shaft 82 defines a vertically-extending longitudinal axis 86 of the hinge pin 68. As described in greater detail below, the right-hand door 24 is configured to pivot about the axis 86 to move between the closed position and the open position when the hinge assembly 30 and the door 24 are assembled. The shaft 82 of the pin body 74 has an outer surface 88 and a plurality of grooves or slots 90 defined in the outer surface 88. As shown in FIG. 4, each slot 90 has an opening 92 defined in the upper end 84 of the body 74. A concave surface 94 extends downwardly from each opening 92 and inwardly from the outer surface 88 to define each slot 90. The slots 90 extend parallel to the axis 86 and are spaced apart equally from one another around the outer circumference of the cylindrical shaft 82. In the illustrative embodiment, the hinge pin 68 includes six slots 90, but it should be appreciated that in other embodiments the hinge pin 68 may include additional or fewer slots.

Returning to FIG. 2, the body 74 of the hinge pin 68 has an opening 96 defined in the upper end 84 and another opening 98 defined in the lower end 80. An inner wall 100 extends between the openings 96, 98 to define a cylindrical passageway 102 through the hinge pin 68. The inner wall 100 of the body 74 includes a lower surface 104 having a number of internal threads 106 defined therein and an upper surface 108 positioned above the lower surface 104. The upper surface 108 of the inner wall 100 is substantially smooth.

In the illustrative embodiment, the hinge pin 68 is formed as a single monolithic component from a metallic material, such as, for example, cold-formed steel. In other embodiments, the body 74 and the circular flange 76 may be formed as separate components that are assembled. It should be appreciated that the configuration of one or more of those components of the hinge pin 68 may be modified in other embodiments. It should further be appreciated that in other embodiments one or more of the components may be made from a polymeric material, such as, for example, a rigid plastic.

As described above, the lower hinge assembly 30 also includes a coupler body 72 that is configured to be engaged with the hinge pin 68. The coupler body 72 includes an outer shell 114 formed from a polymeric material, such as, for example, nylon. It should be appreciated that in other embodiments the outer shell 114 may be formed from a metallic material, such as, for example, cold-rolled steel. The outer shell 114 has a flange 116 that extends outwardly from a lower end 118 and a cam plate 120 that is formed on an upper end 122.

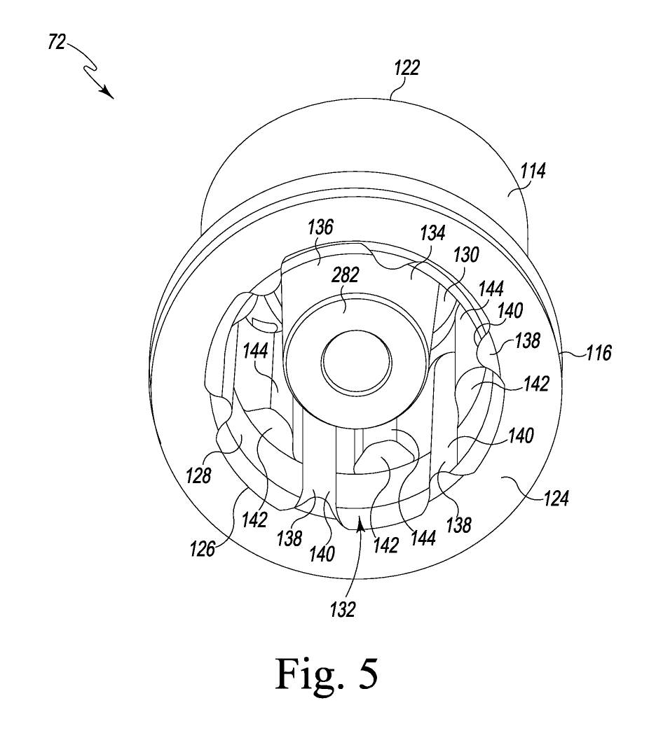

As shown in FIG. 5, the lower end 118 of the coupler body 72 has a circular bottom surface 124. An opening 126 is defined in the bottom surface 124, and an inner wall 128 extends upwardly from the opening 126 to an inner surface 130. The inner wall 128 and the inner surface 130 cooperate to define an aperture 132 in the outer shell 114. The aperture 132 is sized to receive the upper end 84 of the hinge pin 68, as described in greater detail below.

The coupler body 72 of the hinge assembly 30 also includes an inner shaft 134 that extends downwardly from the inner surface 130 of the outer shell 114. The shaft 134 is aligned with the center of the circular opening 126 and is sized to be received in the passageway 102 defined in the hinge pin 68. In the illustrative embodiment, the shaft 134 has an outer surface 136 that is cylindrical. It should be appreciated that in other embodiments the shaft 134 may be tapered or keyed to match the geometric shape of the passageway 102.

As shown in FIG. 5, the coupler body 72 of the hinge assembly 30 has a plurality of ribs 138 that extend from the inner wall 128 into the aperture 132. The ribs 138 are spaced apart equally around the circumference of the inner wall 128. Each rib 138 has a surface 140 that engages the outer surface 88 of the cylindrical shaft 82 of the hinge pin 68 when the hinge assembly 30 is assembled. In the illustrative embodiment, the surface 140 is a convex surface. In other embodiments, the surface 140 may be substantially planar. It should also be appreciated that in other embodiments the ribs 138 may be omitted such that the inner wall 128 of the coupler body 72 may engage the outer surface 88 of the cylindrical shaft 82 of the hinge pin 68 when the hinge assembly 30 is assembled.

The coupler body 72 also includes a plurality of splines 142 that extend from the inner wall 128 into the aperture 132. As shown in FIG. 5, the splines 142 are positioned between the ribs 138 and spaced apart equally around the circumference of the inner wall 128. Each spline 142 is sized to be received in a corresponding slot 90 of the hinge pin 68 and has a cross-sectional geometry that is shaped to match the geometry of the slot 90. In the illustrative embodiment, each spline 142 has a convex surface 144 that matches the concave surface 94 of each slot 90. The number of splines 142 also corresponds to the number of slots 90 defined in the hinge pin 68. Thus, in the illustrative embodiment, the coupler body 72 has six splines 142. Further, in the illustrative embodiment, two of the six splines are larger than the other splines such that the coupler body 72 and the hinge pin 68 are keyed and may be coupled together in one of two orientations.

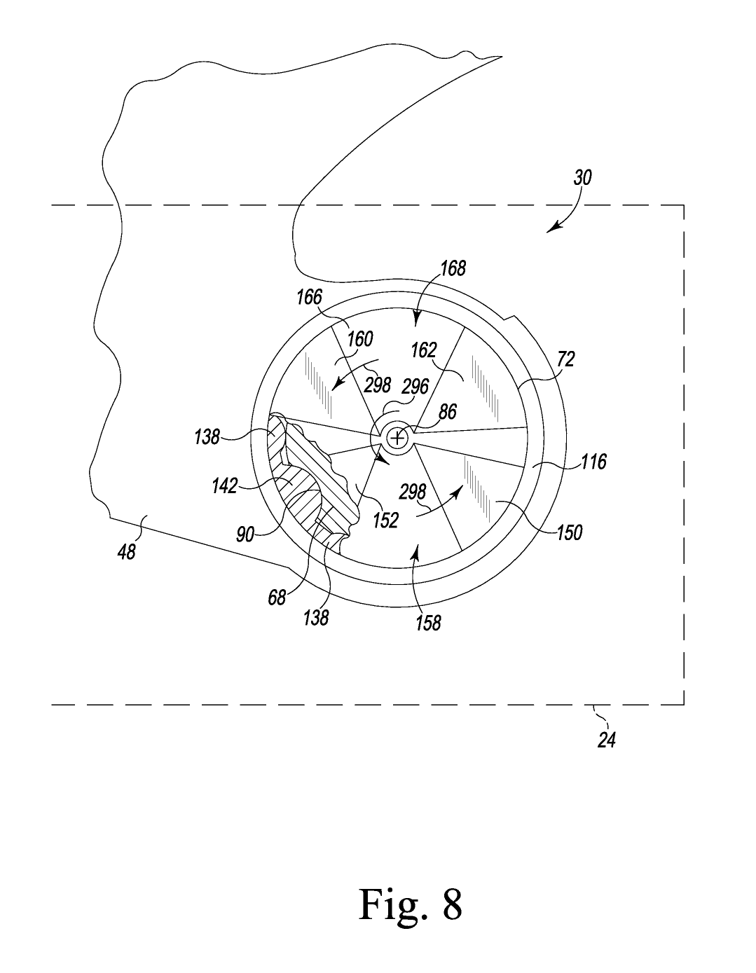

Returning to FIG. 2, a cam plate 120 is formed on the upper end 122 of the coupler body 72. The cam plate 120 includes a pair of angled cam surfaces 150, 152 that extend downwardly from a substantially-planar top surface 154 of the outer shell 114 to a base surface 156. The surfaces 150, 152, 156 cooperate to define a groove 158 in the upper end 122 of the coupler body 72. The cam plate 120 includes another pair of angled cam surfaces 160, 162 positioned on the opposite side of the outer shell 114 (see FIG. 8). The cam surfaces 160, 162, like the cam surfaces 150, 152, extend downwardly from the substantially-planar top surface 154 to a base surface 166. The surfaces 160, 162, 166 cooperate to define a groove 168 in the upper end 122 of the coupler body 72.

As described above, the lower hinge assembly 30 also includes a bushing 70 configured to be secured to the right-hand door 24. As shown in FIGS. 2 and 3, the bushing 70 has a body 180 and a flange 182 that extends outwardly from a lower end 184. As described in greater detail below, the body 180 is keyed to match the passageway 238 defined in the door 24, and includes a rib (not shown) to align the body 180 with the door 24. An opening 186 is defined in a bottom surface 188 of the bushing 70, and an inner wall 190 extends upwardly from the opening 186 to an inner surface 190. The inner wall 190 of the body 180 is cylindrical, and the inner wall 190 cooperates with the inner surface 192 define a cylindrical aperture 194 in the body 180. The aperture 194 is sized to receive the upper end 122 of the coupler body 72, as described in greater detail below.

The bushing 70 also includes a cam plate 200 that is formed on the inner surface 190 of the body 180. The cam plate 200 includes a pair of wedges 202 sized to be received in the grooves 158, 168 of the cam plate 120 of the coupler body 72. Each wedge 202 includes a pair of angled cam surfaces 204, 206. When the bushing 70 is assembled with the coupler body 72, the cam surfaces 204, 206 of one wedge 202 engage the cam surfaces 150, 152 of the coupler body 72 and the cam surfaces 204, 206 of the other wedge 202 engage the cam surfaces 160, 162 of the coupler body 72.

As shown in FIG. 3, the body 180 of the bushing 70 has a plurality of planar outer side walls 210. In the illustrative embodiment, the body 180 has eight side walls 210 such that the outer geometry of the body 180 is octagonal. It should be appreciated that in other embodiments the body 180 may have additional or fewer side walls. The bushing 70 is formed from a polymeric material, such as, for example, acetal. In other embodiments, the bushing 70 may be formed from a metallic material such as cold-formed steel.

As shown in FIG. 2, the refrigerator 10 also includes a door stop bracket 214 for the right-hand door 24. The door stop bracket 214 is formed from a metallic material, such as, for example, steel, but it should be appreciated that in other embodiments the bracket 214 may be formed from a hard polymeric material. The door stop bracket 214 has a horizontally-extending flange 216 configured to be secured to the door 24 and a front flange 218 extending downwardly from the flange 216. A through-hole 220 is defined in the flange 216 and is sized to receive the body 180 of the bushing 70. In the illustrative embodiment, the through-hole 220 is defined a plurality of side walls (not shown) and has an octagonal shape to match the outer geometry of the body 180.

The right-hand door 24 of the refrigerator 10 has a front panel 34 that is secured to a frame 222. The frame 222 has a slot 224 defined in a lower end 226 thereof, and the slot 224 is sized to receive the flange 216 of the door stop bracket 214. As shown in FIG. 2, the frame 222 includes a plurality of side walls 230 and a lower wall 232 that define the slot 224. The bracket 214 may be secured to the door 24 via one or more fasteners (not shown).

The lower wall 232 of the frame 222 has an opening 234 defined therein, and a plurality of inner walls 236 extend upwardly from the opening 234 to define a passageway 238 in the frame 222. The passageway 238 is sized to receive the body 180 of the bushing 70. When the door 24 is assembled with the hinge assembly 30, the inner walls 236 of the frame 222 confront the outer side walls 210 of the bushing 70. In that way, relative axial movement between the bushing 70 and the door 24 is prevented, and the bushing 70 pivots with the door 24 as the door 24 moves between the open position and the closed position.

The hinge assembly 30 of the right-hand door 24 further includes an adjustment mechanism 250 configured to move the door 24 vertically relative to the cabinet 12. In the illustrative embodiment, the adjustment mechanism 250 includes a rod 252 that is sized to be positioned in the passageway 102 of the hinge pin 68. The rod 252 has a plurality of external threads 254 defined on an outer surface 256 thereof. The external threads 254 of the rod 252 correspond to the internal threads 106 of the hinge pin 68. When the rod 252 is positioned in the passageway 102, the external threads 254 of the rod 252 engage the internal threads 106 of the hinge pin 68. The threaded engagement between the rod 252 and the hinge pin 68 permits the rod 252 to be rotated about the axis 86 extending through the hinge pin 68.

The lower end 258 of the rod 252 has a socket 260 defined therein to receive a tool that may be used to rotate the rod 252 about the axis 86. When the rod 252 is rotated in the direction indicated by arrow 262, the rod 252 is moved upward, toward the upper opening 96. When the rod 252 is rotated in the opposite direction, the rod 252 is moved downward, toward the lower opening 98 of the hinge pin 68. Because the upper inner surface 108 of hinge pin 68 is smooth, the rod 252 is prevented from advancing beyond a predetermined position in the passageway 102. In that way, the upper inner surface 108 is a travel stop 264 for the adjustment mechanism 250. It should be appreciated that in other embodiments the hinge pin 68, for example, may include one or more tabs, lips, or other structures to provide a mechanical stop for the adjustment mechanism 250.

To assemble the hinge assembly 30, the hinge pin 68 is attached to the mounting plate 48. To do so, the tail 78 of the hinge pin 68 is aligned with the bore 58 of the mounting plate 48. The hinge pin 68 is advanced downward so that the tail 78 is received in the bore 58, and the flange 76 is moved into contact with the upper surface 50 of the mounting plate 48. In the illustrative embodiment, the tail 78 is swaged to shape the lower end 80 of the tail 78 into a circular flange 270, as shown in FIG. 2. The circular flange 270 is engaged with the lower surface 52 of the mounting plate 48, and the mounting plate 48 is clamped between the flanges 76, 270 of the hinge pin 68 to join the hinge pin 68 and the mounting plate 48 together. The engagement between the flanges 76, 270 and the mounting plate 48 fix the hinge pin 68 in position and prevent the hinge pin 68 from rotating about the axis 86. It should be appreciated that in other embodiments the hinge pin 68 may be joined to the mounting plate 48 by welding, a mechanical fastener, or other means.

When the hinge pin 68 is secured to the mounting plate 48, the coupler body 72 of the hinge assembly 30 is positioned above the hinge pin 68. The cylindrical shaft 82 is aligned with the aperture 132 defined in the coupler body 72, and the splines 142 of the coupler body 72 are aligned with the slots 90 defined in the hinge pin 68. The coupler body 72 is moved downward, and the inner shaft 134 of the coupler body 72 is advanced into the passageway 102 of the hinge pin 68 as the shaft 82 is moved into the aperture 132. Additionally, each spline 142 is advanced into one of the slots 90.

To attach the bushing 70 to the coupler body 72, the bushing 70 is positioned above the coupler body 72 such that the outer shell 114 is aligned with the aperture 194 defined in the bushing 70. The bushing 70 is moved downward to position the outer shell 114 in the aperture 194 and to engage the cam plate 120 of the coupler body 72 with the cam plate 200 of the bushing 70. The bushing 70 may be rotated about the longitudinal axis 86 to advance the wedges 202 of the cam plate 200 into the grooves 158, 168 of the cam plate 120.

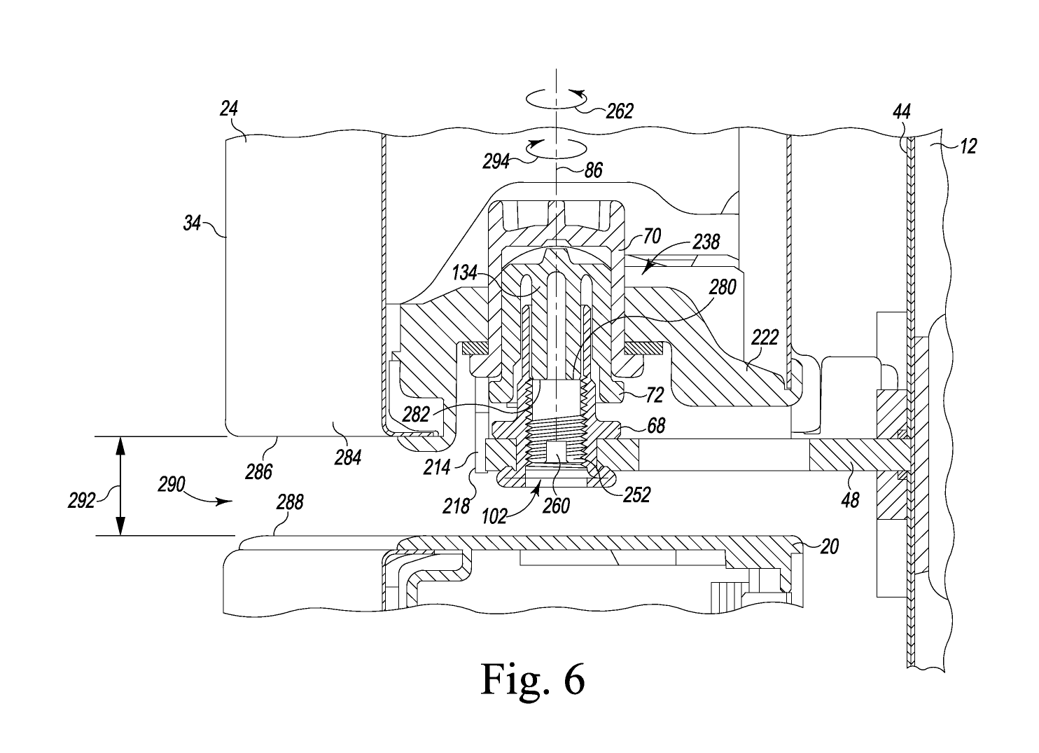

It should be appreciated that the bushing 70 may be secured to the frame 222 of the right-hand door 24 before or after the bushing 70 is attached to the coupler body 72. To do so, the door 24 is positioned above the bushing 70, and the body 180 of the bushing 70 is aligned with the passageway 238 defined the frame 222. The door 24 may be moved downward (or the bushing 70 upward) to advance the bushing 70 into the passageway 238. As described above, the inner walls 236 of the frame 222 engage the outer side walls 210 of the bushing 70 when the bushing 70 is attached to the door 24, thereby preventing relative axial movement between the bushing 70 and the door 24. When the door 24 is properly seated on the bushing 70, the lower flange 182 of the bushing 70 engages the flange 216 of the door stop bracket 214, as shown in FIG. 6.

When the door 24 and the hinge assembly 30 are coupled together, the adjustment mechanism 250 may be used to change the vertical position of the door 24. To do so, the rod 252 may be attached to the lower end 80 of the hinge pin 68 and a wrench or other tool may be attached to the socket 260 of the rod 252. The wrench may be used to rotate the rod 252 about the axis 86 in the direction indicated by arrow 262 to move the rod 252 upward along the passageway 102 of the hinge pin 68. As the rod 252 is moved upward, the upper end 280 of the rod 252 is advanced into contact with the lower end 282 of the inner shaft 134 of the coupler body 72. When the rod 252 is engaged with the coupler body 72, continued upward movement of the rod 252 causes the coupler body 72, the bushing 70, and the door 24 to move upward to the position shown in FIG. 6.

As shown in FIG. 6, the front panel 34 of the right-hand door 24 has a lower end 284 positioned in front of the flange 218 of the door stop bracket 214. The front panel 34 also has a bottom surface 286 that faces a top surface 288 of the drawer 20 of the refrigerator 10. A gap 290 is defined between the surfaces 286, 288 when the door 24 is attached to the hinge assembly 30. As shown in FIG. 6, the gap 290 has a magnitude 292 of approximately twelve millimeters.

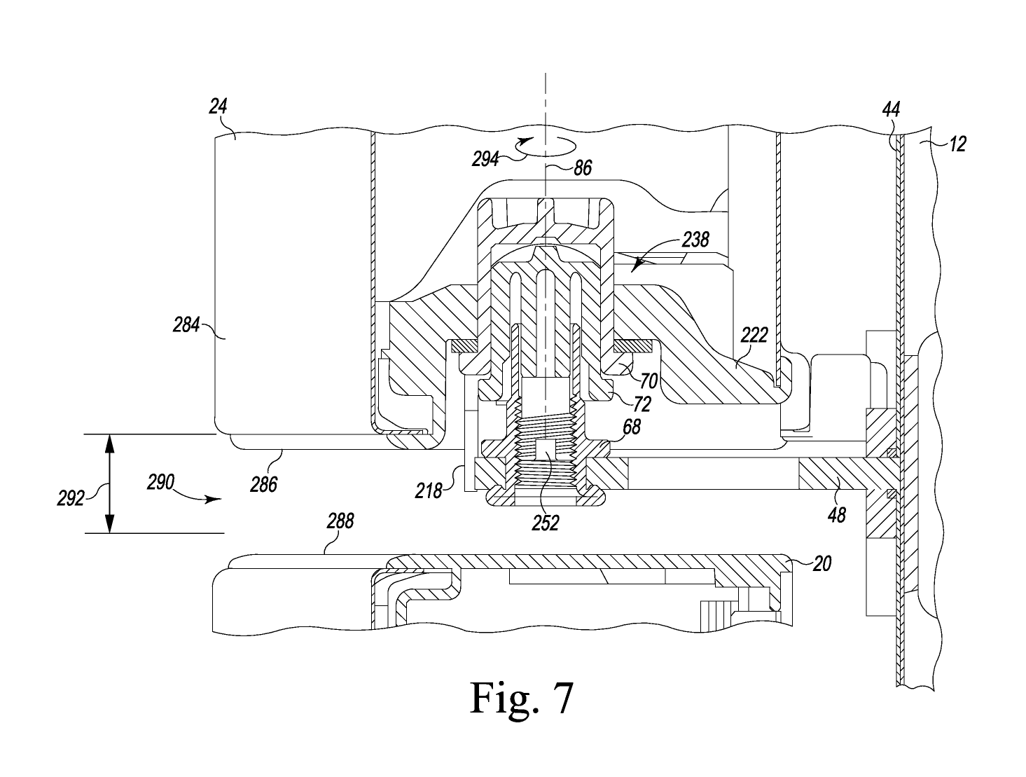

The size of the gap 290 corresponds to the vertical position of the door 24 relative to the cabinet 12. The adjustment mechanism 250 may be used to move the right-hand door 24 higher or lower from the position shown in FIG. 6, and thereby change the size of the gap 290. To do so, the rod 252 may be rotated about the axis 86 in the direction indicated by arrow 262 to move the rod 252 upward along the passageway 102 of the hinge pin 68. As described above, the upward movement of the rod 252 causes the coupler body 72, the bushing 70, and the door 24 to move upward. When the rod 252 reaches the travel stop 264, as shown in FIG. 7, the travel stop 264 prevents further upward movement of the rod 252. In that position, the gap 290 has a magnitude 292 of approximately sixteen millimeters. In that way, the door 24 may be lifted approximately three millimeters between the position shown in FIG. 6 and the position shown in FIG. 7.

When the rod 252 is rotated about the axis 86 in the direction indicated by arrow 294, the rod 252 may be moved downward along the passageway 102 of the hinge pin 68. The movement of the rod 252 causes the coupler body 72, the bushing 70, and the door 24 to move downward until the inner surface 130 of the coupler body 72 is advanced into contact with the upper end 84 of the hinge pin 68, thereby preventing further downward movement of the hinge assembly 30 and the door 24. In that position, the gap 290 has a magnitude of approximately ten millimeters. Thus, in the illustrative embodiment, the vertical position of the door 24 relative to the drawer 20 (and hence the cabinet 12) may be adjusted by approximately six millimeters.

As described above, the right-hand door 24 may be pivoted about the axis 86 to move the door 24 between the open position and the closed position. When the door 24 is in the closed position, the cam surfaces 204, 206 of the wedges 202 of the cam plate 200 of the bushing 70 confront the corresponding cam surfaces 150, 152, 160, 162 of the cam plate 120 of the coupler body 72. When the door 24 is opened, the door 24 is pivoted about the axis 86 as indicated by arrow 296 in FIG. 8. As the door 24 is pivoted, the wedges 202 of the cam plate 200 apply a load to the cam surfaces 150, 160 of the coupler body 72 in the direction indicated by arrows 298 in FIG. 8.

The load is transferred through the coupler body 72 to the hinge bracket 40 via the hinge pin 68. The engagement between the splines 142 of the coupler body 72 and the slots 90 of the hinge pin 68 prevents the coupler body 72 from pivoting with the door 24 and the bushing 70. As a result, the wedges 202 of the bushing 70 slide upwardly along the cam surfaces 150, 160 of the coupler body 72 as the door 24 is pivoted about the axis 86, thereby lifting the door 24 as the door 24 is opened. When the door 24 is moved to the open position, the door stop bracket 214 is advanced into the pocket 62 defined in the mounting plate 48. The door stop bracket 214 engages the side wall 62 and the flange 64 such that further movement of the door 24 about the axis 86 is prevented.

When the door 24 is moved from the open position to the closed position, the wedges 202 of the bushing 70 advance along the top surfaces 154 of the cam plate 120 of the coupler body 72 and then downward along the cam surfaces 150, 160 of the lower cam plate 120 such that the door 24 is lowered as the door 24 is moved to the closed position.

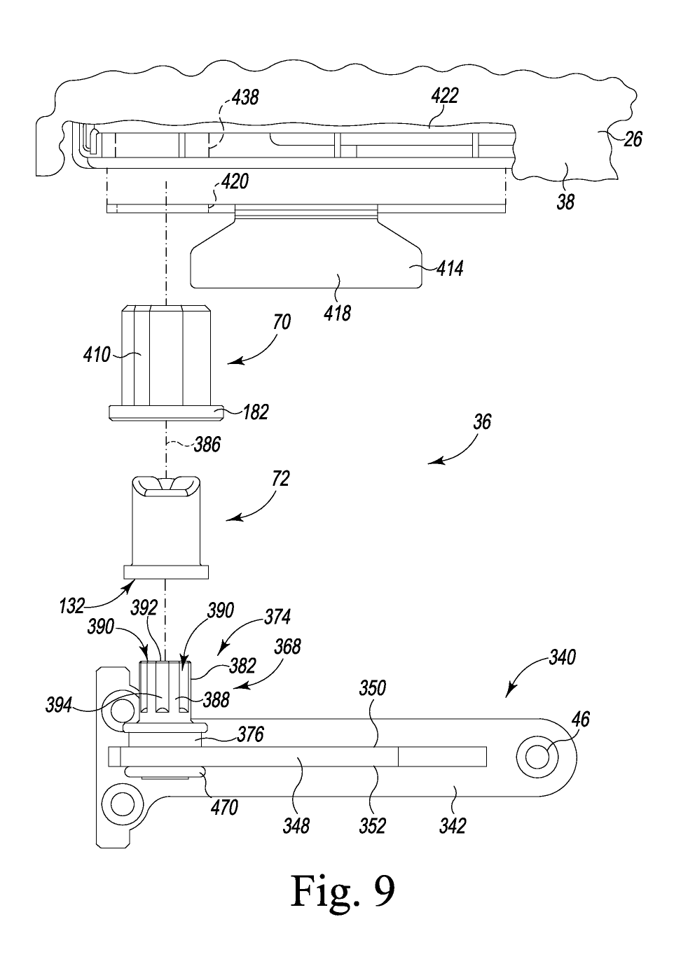

As described above, the refrigerator 10 also includes a left-hand door 26 that is hinged to the front of the cabinet 12 via an upper hinge assembly 28 and a lower hinge assembly 36. Referring now to FIG. 9, the lower hinge assembly 36 is configured to be secured to a hinge bracket 340. The hinge bracket 340 is formed from a metallic material, such as, for example, steel, and is sized to support the weight of the left-hand door 26. The hinge bracket 340, like the hinge bracket 40, includes a vertical flange 342 configured to be attached to the front wall 44 of the cabinet 12 via a plurality of bolts (not shown), which extend through holes 46 formed in the flange 342 and engage the cabinet 12. The hinge bracket 340 also includes a mounting plate 348 that extends horizontally from the flange 342.

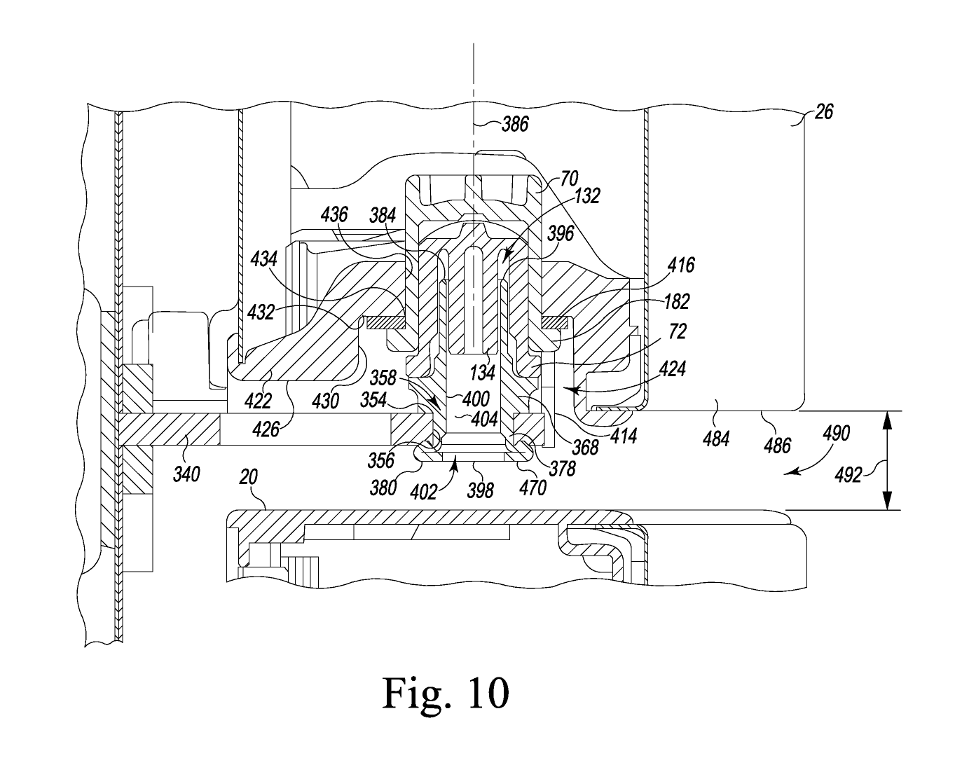

The mounting plate 348 of the hinge bracket 340 extends outwardly from the cabinet 12 when the bracket 340 is secured to the cabinet 12. The mounting plate 348 has an upper surface 350 and a lower surface 352 positioned opposite the upper surface 350. As shown in FIG. 10, an opening 354 is defined in the upper surface 350 of the mounting plate 348, and an inner wall 356 extends downwardly from the opening 354 to define a bore 358 through the mounting plate 348. In the illustrative embodiment, the opening 354 is circular, and the bore 358 is substantially cylindrical. It should be appreciated that in other embodiments the opening may be oblong, square, or other geometric shapes.

The lower hinge assembly 36 of the left-hand door 26 includes a hinge pin 368 configured to be secured to the hinge bracket 340, a bushing 70 configured to be secured to the left-hand door 26, and a coupler body 72 positioned between the hinge pin 368 and the bushing 70. As shown in FIG. 9, the hinge pin 368 has a body 374 and a flange 376 that extends outwardly from the body 374. The body 374 has a tail 378 that extends downwardly from the flange 376 to a lower end 380. The tail 378 has a cross-sectional geometry that is shaped to match the bore 358 of the mounting plate 348. In the illustrative embodiment, the tail 378 is cylindrical and has an outer diameter that is sized such that the tail 378 may be received in the bore 358.

The body 374 of the hinge pin 368 includes a cylindrical shaft 382, which extends upwardly from the flange 376 to an upper end 384. The shaft 382 defines a vertically-extending longitudinal axis 386 of the hinge pin 368, and the left-hand door 26 is configured to pivot about the axis 86 between the open and closed positions when the hinge assembly 36 and the door 26 are assembled (see FIG. 10). The shaft 382 of the pin body 374 has an outer surface 388 and a plurality of grooves or slots 390 defined in the outer surface 388. As shown in FIG. 9, each slot 390 has an opening 392 defined in the upper end 384 of the body 374. A concave surface 394 extends downwardly from each opening 392 and inwardly from the outer surface 388 to define each slot 390. The slots 390 extend parallel to the axis 86 and are spaced equally apart from one another around the outer circumference of the cylindrical shaft 382. In the illustrative embodiment, the hinge pin 368 includes six slots 390, but it should be appreciated that in other embodiments the hinge pin 368 may include additional or fewer slots.

As shown in FIG. 10, the body 374 of the hinge pin 368 has an opening 396 defined in the upper end 384 and another opening 398 defined in the lower end 380. An inner wall 400 extends between the openings 396, 398 to define a cylindrical passageway 402 through the hinge pin 368. The surface 404 of the inner wall 400 is substantially smooth.

As described above, the lower hinge assembly 36 also includes a coupler body 72 that is configured to be engaged with the hinge pin 368. In the illustrative embodiment, the coupler body 72 used in the lower hinge assembly 36 of the left-hand door 26 is identical to the coupler body 72 used in the lower hinge assembly 30 of the right-hand door 24. Similarly, the bushing 70 used in the lower hinge assembly 36 of the left-hand door 26 is identical to the bushing 70 used in the lower hinge assembly 30 of the right-hand door 24.

As shown in FIG. 2, the refrigerator 10 also includes a door stop bracket 414 for the left-hand door 26. The door stop bracket 414 has a horizontally-extending flange 416 configured to be secured to the door 24 and a front flange 418 extending downwardly from the flange 416. A through-hole 420 is defined in the flange 416 and, like the through-hole 220 of the door stop bracket 214, is sized to receive the body 180 of the bushing 70. In the illustrative embodiment, the through-hole 420 is defined a plurality of side walls (not shown) and has an octagonal shape to match the outer geometry of the body 180.

The left-hand door 26 of the refrigerator 10 has a front panel 38 that is secured to a frame 422. The frame 422 has a slot 424 defined in a lower end 426 thereof that is sized to receive the flange 416 of the door stop bracket 414. As shown in FIG. 10, the frame 422 includes a plurality of side walls 430 and a lower wall 432 that define the slot 424. The bracket 414 may be secured to the door 26 via one or more fasteners (not shown).

The lower wall 432 of the frame 422 has an opening 434 defined therein, and a plurality of inner walls 436 define a passageway 438 in the frame 422. The passageway 438 is sized to receive the body 180 of the bushing 70. When the door 26 is assembled with the hinge assembly 36, the inner walls 436 of the frame 422 confront the outer side walls 410 of the bushing 70, as shown in FIG. 10. In that way, relative axial movement between the bushing 70 and the door 26 is prevented such that the bushing 70 pivots with the door 26 as the door 26 moves between the open position and the closed position.

To assemble the hinge assembly 36, the hinge pin 368 is attached to the mounting plate 348. To do so, the tail 378 of the hinge pin 368 is aligned with the bore 358 of the mounting plate 348. The hinge pin 368 is advanced downward so that the tail 378 is received in the bore 358, and the flange 376 is moved into contact with the upper surface 350 of the mounting plate 348. In the illustrative embodiment, the tail 378 is swaged to shape the lower end 380 of the tail 378 into a circular flange 470, as shown in FIG. 10. The circular flange 470 is engaged with the lower surface 352 of the mounting plate 348. The mounting plate 348 is clamped between the flanges 376, 470 of the hinge pin 368, thereby joining the hinge pin 368 and the mounting plate 348 together. It should be appreciated that in other embodiments the hinge pin 368 may be joined to the mounting plate 348 by welding, a mechanical fastener, or other means.

When the hinge pin 368 is secured to the mounting plate 348, the coupler body 72 of the hinge assembly 30 is positioned above the hinge pin 368. The cylindrical shaft 382 of the hinge pin 368 is aligned with the aperture 132 defined in the coupler body 72, and the splines 142 of the coupler body 72 are aligned with the slots 390 defined in the hinge pin 368. The coupler body 72 is moved downward, and the inner shaft 134 of the coupler body 72 is advanced into the passageway 402 of the hinge pin 368 as the shaft 382 of the hinge pin 368 is received in the aperture 132. Additionally, the each spline 142 of the coupler body 72 is advanced into one of the slots 390.

The bushing 70 may be attached to the coupler body 72 as described above. It should be appreciated that the bushing 70 may be secured to the frame 422 of the left-hand door 26 before or after the bushing 70 is attached to the coupler body 72. To do so, the door 26 is positioned above the bushing 70 such that the body 180 of the bushing 70 is aligned with the passageway 438 defined the frame 422. The door 26 may be moved downward (or the bushing 70 upward) to advance the bushing 70 into the passageway 438. As described above, the inner walls 436 of the frame 422 engage the outer side walls 210 of the bushing 70 when the bushing 70 is attached to the door 26, thereby preventing relative axial movement between the bushing 70 and the door 26. When the door 26 is properly seated on the bushing 70, the lower flange 182 of the bushing 70 engages the flange 416 of the door stop bracket 414, as shown in FIG. 10.

The front panel 38 of the left-hand door 26 has a lower end 484 positioned in front of the flange 418 of the door stop bracket 414. The front panel 38 also has a bottom surface 486 that faces a top surface 288 of the drawer 20 of the refrigerator 10. A gap 490 is defined between the surfaces 486, 288 when the door 26 is attached to the hinge assembly 36. As shown in FIG. 10, the gap 490 has a magnitude 492 of approximately thirteen millimeters.

As described above, the left-hand door 26 may be pivoted about the axis 386 to move the door 26 between the closed position and the open position. When the door 26 is opened, the door 26 is pivoted about the axis 386 and a load is applied to the coupler body 72 by the cam plate 200 of the bushing 70. The engagement between the splines 142 of the coupler body 72 and the slots 390 of the hinge pin 368 prevents the coupler body 72 from pivoting with the door 26 and the bushing 70. As with the lower hinge assembly 30 of the right-hand door 24, the interaction between the coupler body 72 and the bushing 70 lifts the door 26 as the door 26 is moved between positions.

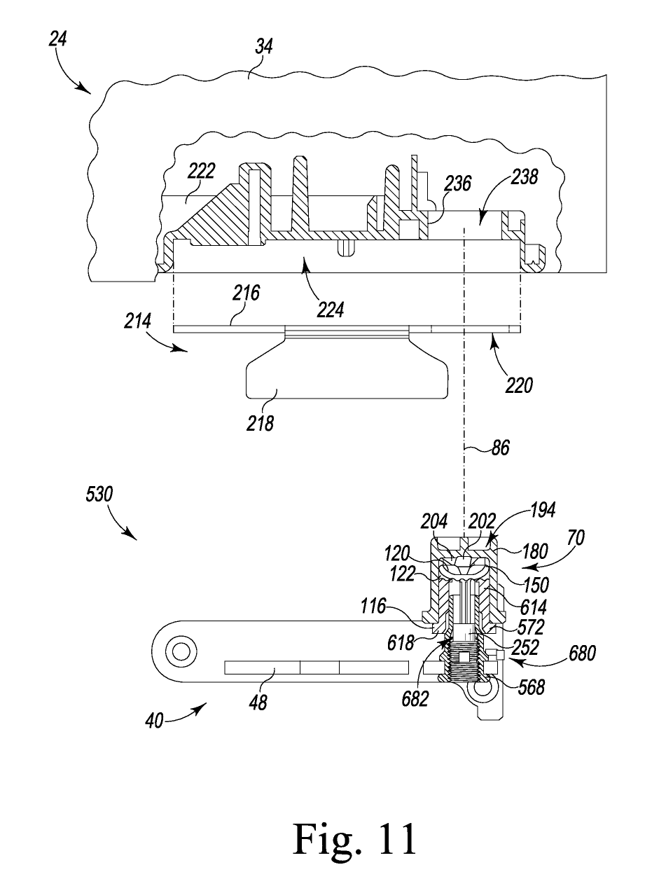

Referring now to FIGS. 11-14, another embodiment of a lower hinge assembly (hereinafter lower hinge assembly 530) is illustrated. Some features of the embodiment illustrated in FIGS. 11-14 are substantially similar to those discussed above in reference to the embodiment of FIGS. 1-9. Such features are designated in FIGS. 11-14 with the same reference numbers as those used in FIGS. 1-9.

The lower hinge assembly 530 is configured to be secured to a hinge bracket 40. As shown in FIG. 11, the hinge bracket 40 includes a vertical flange 42 and a mounting plate 48 that extends horizontally from the flange 42. The mounting plate 48 has an upper surface 50 and a lower surface 52 positioned opposite the upper surface 50. An opening 54 is defined in the upper surface 50 of the mounting plate 48, and an inner wall 56 extends downwardly from the opening 54 to define a bore 58 through the mounting plate 48.

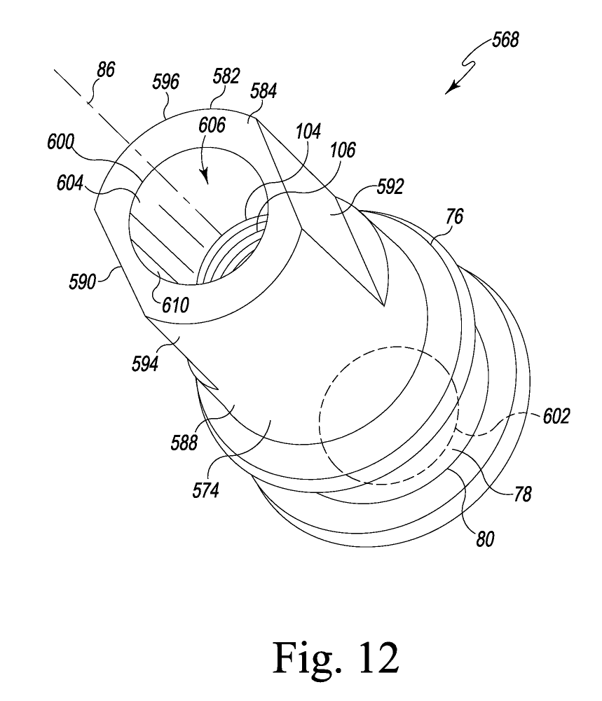

As shown in FIGS. 11-14, the lower hinge assembly 530 includes a hinge pin 568 configured to be secured to the hinge bracket 40, a bushing 70 configured to be secured to the right-hand door 24, and a coupler body 572 positioned between the hinge pin 568 and the bushing 70. As shown in FIG. 12, the hinge pin 568 has a body 574 and a circular flange 76 that extends outwardly from the body 574. The body 574 has a tail 78 that extends downwardly from the circular flange 76 to a lower end 80. The tail 78 has a cross-sectional geometry that is shaped to match the bore 58 of the mounting plate 48. In the illustrative embodiment, the tail 78 is cylindrical and has an outer diameter that is sized such that the tail 78 may be received in the bore 58.

The body 574 of the hinge pin 568 includes a cylindrical shaft 582, which extends upwardly from the circular flange 76 to an upper end 584. The shaft 582 defines a vertically-extending longitudinal axis 86 of the hinge pin 568. As described in greater detail below, the right-hand door 24 is configured to pivot about the axis 86 to move between the closed position and the open position when the hinge assembly 30 and the door 24 are assembled. The shaft 582 of the pin body 574 has an outer surface 588 that includes a pair of substantially planar surfaces 590, 592 and a pair of convex surfaces 594, 596. The surfaces 594, 596 extend between the surfaces 590, 592 and connect the surfaces 590, 592 to one another.

The body 574 of the hinge pin 568 has an opening 600 defined in the upper end 584 and another opening 602 defined in the lower end 80. An inner wall 604 extends between the openings 600, 602 to define a cylindrical passageway 606 through the hinge pin 568. The inner wall 604 of the body 574 includes a lower surface 104 having a number of internal threads 106 defined therein and an upper surface 610 positioned above the lower surface 104. The upper surface 610 of the inner wall 604 is tapered and substantially smooth.

In the illustrative embodiment, the hinge pin 568 is formed as a single monolithic component from a metallic material, such as, for example, cold-formed steel. In other embodiments, the body 574 and the circular flange 76 may be formed as separate components that are assembled. It should be appreciated that the configuration of one or more of those components of the hinge pin 568 may be modified in other embodiments. It should further be appreciated that in other embodiments one or more of the components may be made from a polymeric material, such as, for example, a rigid plastic.

As described above, the lower hinge assembly 530 also includes a coupler body 572 that is configured to be engaged with the hinge pin 568. Returning to FIG. 11, the coupler body 572 includes an outer shell 614 formed from a polymeric material, such as, for example, nylon. It should be appreciated that in other embodiments the outer shell 614 may be formed from a metallic material, such as, for example, cold-rolled steel. The outer shell 614 has a flange 116 that extends outwardly from a lower end 618 and a cam plate 120 that is formed on an upper end 122.

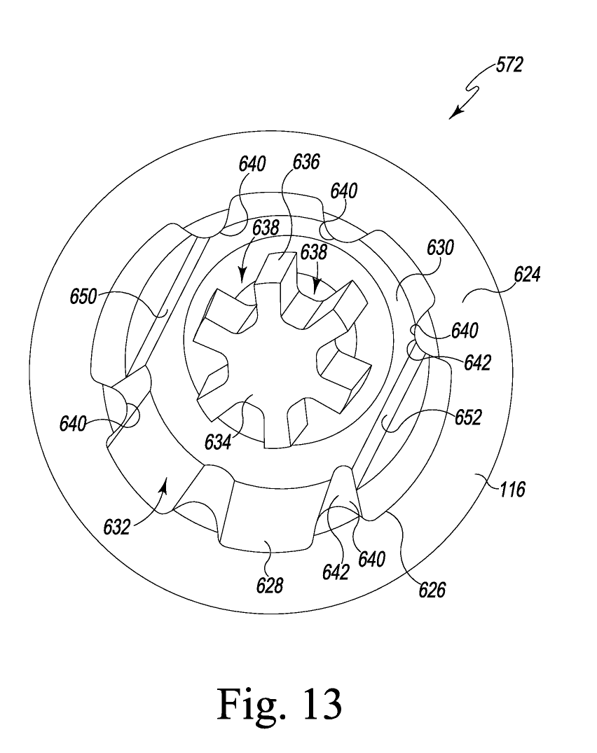

As shown in FIG. 13, the lower end 618 of the coupler body 72 has a circular bottom surface 624. An opening 626 is defined in the bottom surface 624, and an inner wall 628 extends upwardly from the opening 626 to an inner surface 630. The inner wall 628 and the inner surface 630 cooperate to define an aperture 632 in the outer shell 614. The aperture 632 is sized to receive the upper end 584 of the hinge pin 568, as described in greater detail below.

The coupler body 572 of the hinge assembly 530 also includes an inner shaft 634 that extends downwardly from the inner surface 630 of the outer shell 614. The shaft 634 is aligned with the center of the circular opening 626 and is sized to be received in the passageway 606 defined in the hinge pin 568. In the illustrative embodiment, the shaft 634 has an outer surface 636 that is tapered and has a plurality of longitudinal grooves 638 defined therein. It should be appreciated that in other embodiments the shaft 634 may be cylindrical or keyed to match the geometric shape of the passageway 606.

As shown in FIG. 13, the coupler body 72 of the hinge assembly 530 has a plurality of ribs 640 that extend from the inner wall 628 into the aperture 632. The ribs 640 are spaced apart around the circumference of the inner wall 628. Each rib 640 has a surface 642 that engages one of the pair of convex surfaces of 594, 596 of the hinge pin 568 when the hinge assembly 530 is assembled. In the illustrative embodiment, the surface 642 of the rib 640 is a convex surface. In other embodiments, the surface 642 may be substantially planar. It should also be appreciated that in other embodiments the ribs 640 may be omitted such that the inner wall 628 of the coupler body 572 may engage the convex surfaces of 594, 596 of the hinge pin 68 when the hinge assembly 530 is assembled.

The inner wall 628 of the coupler body 572 has a pair of substantially planar surfaces 650, 652. As shown in FIG. 13, the surfaces 650, 652 are positioned on opposite sides of the inner shaft 634. The surfaces 650, 652 are configured to engage the surfaces 590, 592, respectively, of the hinge pin 568. The number of substantially planar surfaces formed on the coupler body 572 corresponds to the number of substantially planar surfaces formed on the hinge pin 568.

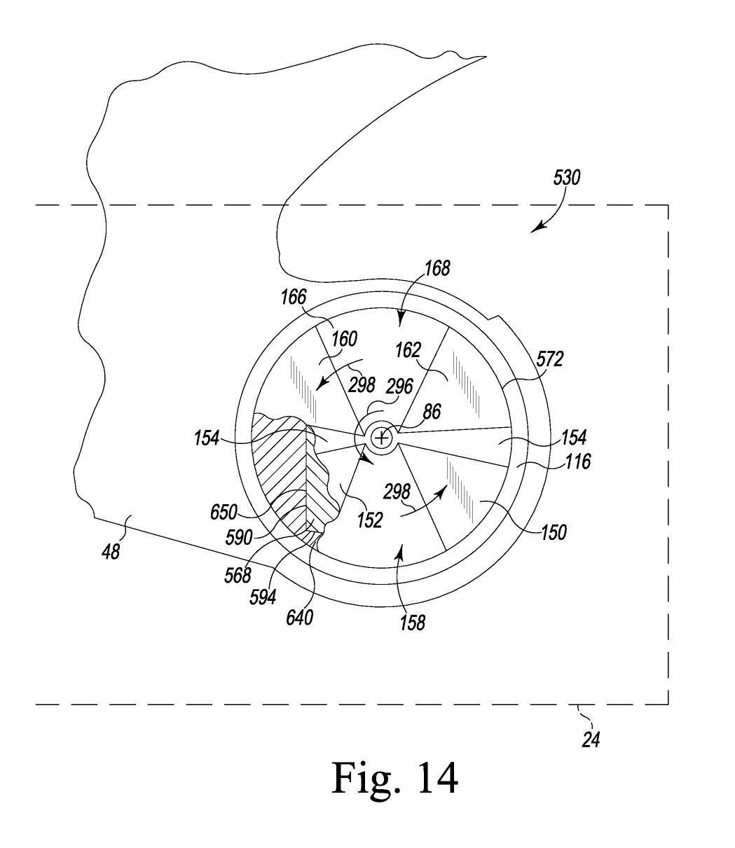

Returning to FIG. 11, a cam plate 120 is formed on the upper end 122 of the coupler body 572. The cam plate 120 includes a pair of angled cam surfaces 150, 152 that extend downwardly from a substantially-planar top surface 154 of the outer shell 114 to a base surface 156. As shown in FIG. 14, the surfaces 150, 152, 156 cooperate to define a groove 158 in the upper end 122 of the coupler body 72. The cam plate 120 includes another pair of angled cam surfaces 160, 162 positioned on the opposite side of the outer shell 614. The cam surfaces 160, 162, like the cam surfaces 150, 152, extend downwardly from the substantially-planar top surface 154 to a base surface 166. The surfaces 160, 162, 166 cooperate to define a groove 168 in the upper end 122 of the coupler body 572.

As described above, the lower hinge assembly 530 also includes a bushing 70 configured to be secured to the right-hand door 24. As shown in FIG. 11, the bushing 70 has a body 180 and a flange 182 that extends outwardly from a lower end 184. The bushing 70 has a cylindrical aperture 194 defined therein that is sized to receive the upper end 122 of the coupler body 572.

The bushing 70 also includes a cam plate 200 that is formed on the inner surface 190 of the body 180. The cam plate 200 includes a pair of wedges 202 sized to be received in the grooves 158, 168 of the cam plate 120 of the coupler body 572. Each wedge 202 includes a pair of angled cam surfaces 204, 206. When the bushing 70 is assembled with the coupler body 572, the cam surfaces 204, 206 of one wedge 202 engage the cam surfaces 150, 152 of the coupler body 572 and the cam surfaces 204, 206 of the other wedge 202 engage the cam surfaces 160, 162 of the coupler body 572.

As shown in FIG. 11, the door 24 has a front panel 34 that is secured to a frame 222. The refrigerator 10 also includes a door stop bracket 214 for the right-hand door 24 that is secured to the frame 222 via one or more fasteners (not shown). The frame 222 includes a passageway 238 that is sized to receive the body 180 of the bushing 70. When the door 24 is assembled with the hinge assembly 530, the inner walls 236 of the frame 222 confront the outer side walls 210 of the bushing 70. In that way, relative axial movement between the bushing 70 and the door 24 is prevented, and the bushing 70 pivots with the door 24 as the door 24 moves between the open position and the closed position.

The hinge assembly 530 further includes an adjustment mechanism 680 configured to move the door 24 vertically relative to the cabinet 12. In the illustrative embodiment, the adjustment mechanism 680 includes a rod 252 that is sized to be positioned in the passageway 606 of the hinge pin 568. The rod 252 has a plurality of external threads 254 defined on an outer surface 256 thereof. The external threads 254 of the rod 252 correspond to the internal threads 106 of the hinge pin 568. When the rod 252 is positioned in the passageway 606, the external threads 254 of the rod 252 engage the internal threads 106 of the hinge pin 68. The threaded engagement between the rod 252 and the hinge pin 68 permits the rod 252 to be rotated about the axis 86 extending through the hinge pin 68.

The lower end 258 of the rod 252 has a socket 260 defined therein to receive a tool that may be used to rotate the rod 252 about the axis 86. When the rod 252 is rotated in the direction indicated by arrow 262, the rod 252 is moved upward, toward the upper opening 600. When the rod 252 is rotated in the opposite direction, the rod 252 is moved downward, toward the lower opening 602 of the hinge pin 568. Because the upper inner surface 610 of hinge pin 568 is smooth and tapered, the rod 252 is prevented from advancing beyond a predetermined position in the passageway 606. In that way, the upper inner surface 610 is a travel stop 682 for the adjustment mechanism 680. It should be appreciated that in other embodiments the hinge pin 568, for example, may include one or more tabs, lips, or other structures to provide a mechanical stop for the adjustment mechanism 680.

As described above, the right-hand door 24 may be pivoted about the axis 86 to move the door 24 between the open position and the closed position. When the door 24 is in the closed position, the cam surfaces 204, 206 of the wedges 202 of the cam plate 200 of the bushing 70 confront the corresponding cam surfaces 150, 152, 160, 162 of the cam plate 120 of the coupler body 572. When the door 24 is opened, the door 24 is pivoted about the axis 86 as indicated by arrow 296 in FIG. 14. As the door 24 is pivoted, the wedges 202 of the cam plate 200 apply a load to the cam surfaces 150, 160 of the coupler body 572 in the direction indicated by arrows 298 in FIG. 14.

The load is transferred through the coupler body 572 to the hinge bracket 40 via the hinge pin 568. The engagement between the surfaces 650, 652 of the coupler body 572 and the surfaces 590, 592, respectively, of the hinge pin 568 prevents the coupler body 572 from pivoting with the door 24 and the bushing 70. As a result, the wedges 202 of the bushing 70 slide upwardly along the cam surfaces 150, 160 of the coupler body 572 as the door 24 is pivoted about the axis 86, thereby lifting the door 24 as the door 24 is opened.

When the door 24 is moved to from the open position to the closed position, the wedges 202 of the bushing 70 advance along the top surfaces 154 of the cam plate 120 of the coupler body 572 and then downward along the cam surfaces 150, 160 of the lower cam plate 120 such that the door 24 is lowered as the door 24 is moved to the closed position.

While the disclosure has been illustrated and described in detail in the drawings and foregoing description, such an illustration and description is to be considered as exemplary and not restrictive in character, it being understood that only illustrative embodiments have been shown and described and that all changes and modifications that come within the spirit of the disclosure are desired to be protected.

For example, in other embodiments, the left-hand door may have an adjustable hinge assembly operable to raise and lower the left-hand door relative to the cabinet. Similarly, the right-hand door may have a fixed hinge assembly that does not permit the right-hand door to be raised and lowered when the door is in the closed position.

There are a plurality of advantages of the present disclosure arising from the various features of the method, apparatus, and system described herein. It will be noted that alternative embodiments of the method, apparatus, and system of the present disclosure may not include all of the features described yet still benefit from at least some of the advantages of such features. Those of ordinary skill in the art may readily devise their own implementations of the method, apparatus, and system that incorporate one or more of the features of the present invention and fall within the spirit and scope of the present disclosure as defined by the appended claims.

1. A domestic refrigerator comprising:
a cabinet having a temperature-controlled compartment defined therein,
a door operable to pivot about an axis of rotation between (i) a closed position in which user access to the temperature-controlled compartment is prevented and (ii) an open position in which user access to the temperature-controlled compartment is permitted,
a cam plate coupled to the door, the cam plate including a first cam surface,
a coupler body having (i) a second cam surface engaged with the first cam surface, (ii) a lower surface positioned opposite the second cam surface, the lower surface having an opening defined therein, and (iii) an inner wall extending upwardly from the opening to define an aperture in the coupler body, and
a hinge pin defining the axis of rotation, the hinge pin having an upper end positioned in the aperture of the coupler body, the upper end including a pair of substantially planar surfaces and a pair of convex surfaces connecting the pair of substantially planar surfaces,
wherein the inner wall of the coupler body has a pair of substantially planar surfaces engaged with the pair of substantially planar surfaces of the hinge pin to prevent rotation of the coupler body about the axis of rotation.

2. The domestic refrigerator of claim 1, wherein:
the hinge pin has a passageway defined therein,
the inner wall of the coupler body extends upwardly from the opening to an inner surface, and
the coupler body includes a central shaft that extends downwardly from the inner surface, the central shaft having a lower end positioned in the passageway of the hinge pin.

3. The domestic refrigerator of claim 2, further comprising an adjustment mechanism configured to move the door vertically between a first position and a second position relative to the cabinet.

4. The domestic refrigerator of claim 3, wherein the adjustment mechanism includes a threaded rod positioned in the passageway of the hinge pin, the threaded rod having an upper end engaged with the lower end of the central shaft of the coupler body.

5. The domestic refrigerator of claim 4, wherein:
the threaded rod has a plurality of outer threads, and
the hinge pin includes an inner wall that defines the passageway therethrough, the inner wall having a plurality of inner threads defined therein that are engaged with the outer threads of the threaded rod such that (i) rotation of the threaded rod in a first direction causes upward movement of the coupler body and the door, and (ii) rotation of the threaded rod in a second direction causes downward movement of the coupler body and the door.

6. The domestic refrigerator of claim 5, wherein the adjustment mechanism includes a stop configured to prevent upward movement of the threaded rod beyond a predetermined position corresponding to the second position of the door.

7. The domestic refrigerator of claim 6, wherein the stop includes a substantially smooth section of the inner wall of the hinge pin, the substantially smooth section being positioned above the plurality of inner threads.

8. The domestic refrigerator of claim 3, wherein a distance is defined between the first position and the second position, the distance being approximately three millimeters.

9. The domestic refrigerator of claim 1, further comprising a bushing including the cam plate, wherein (i) the door includes a frame and a front panel secured to the frame, and (ii) a bushing secured to the frame and positioned behind the front panel.

10. The domestic refrigerator of claim 9, wherein:
the bushing includes (i) a bottom surface having an opening defined therein, (ii) an inner wall extending upwardly from the opening to an inner surface including the first cam surface, and (iii) an aperture defined by the inner wall and the inner surface, and
the coupler body has an upper end positioned in the aperture of the bushing.

11. A domestic refrigerator comprising:
a door operable to pivot about an axis of rotation,
a cam plate coupled to the door, the cam plate including a first cam surface,
a coupler body having (i) a second cam surface engaged with the first cam surface, (ii) a lower surface having an opening defined therein, and (iii) an inner wall extending upwardly from the opening to define an aperture in the coupler body, the inner wall including a pair of substantially planar surfaces,
a hinge pin defining the axis of rotation, the hinge pin having an upper end positioned in the aperture of the coupler body, the upper end including a pair of substantially planar surfaces engaged with the pair of substantially planar surfaces of the coupler body to prevent rotation of the coupler body about the axis of rotation, and
a threaded rod positioned in a passageway defined in the hinge pin and engaged with the coupler body, the threaded rod being configured to rotate in (i) a first direction to cause upward movement of the door and (ii) a second direction to cause downward movement of the door.

12. The domestic refrigerator of claim 11, wherein:
the inner wall of the coupler body extends upwardly from the opening to an inner surface, the inner wall and the inner surface defining the aperture in the coupler body, and
the coupler body includes a central shaft that extends downwardly from the inner surface, the central shaft having a lower end (i) positioned in the passageway of the hinge pin and (ii) engaged with an upper end of the threaded rod.

13. The domestic refrigerator of claim 11, further comprising a stop positioned in the passageway defined in the hinge pin, the stop being configured to prevent upward movement of the threaded rod beyond a predetermined position.

14. The domestic refrigerator of claim 11, wherein:
the upper end of the hinge pin includes a pair of convex surfaces that connect the pair of substantially planar surfaces of the hinge pin, and
the coupler body includes a plurality of ribs extending inwardly from the inner wall, the plurality of ribs being engaged with the pair of convex surfaces of the hinge pin.

15. The domestic refrigerator of claim 11, further comprising:
a bushing secured to the door, the bushing including (i) a bottom surface having an opening defined therein, (ii) an inner wall extending upwardly from the opening to an inner surface that includes the first cam surface, and (iii) the aperture is defined by the inner wall and the inner surface, and
the coupler body has an upper end positioned in the aperture of the bushing, the upper end of the coupler body including the second cam surface.

16. A domestic refrigerator comprising:
a cabinet having a temperature-controlled compartment defined therein,
a door operable to pivot about an axis of rotation between (i) a closed position in which user access to the temperature-controlled compartment is prevented and (ii) an open position in which user access to the temperature-controlled compartment is permitted,
a bushing secured to the door, the bushing having (i) an aperture defined therein, and (ii) a first cam surface positioned in the aperture,
a coupler body having (i) an upper end positioned in the aperture of the bushing, the upper end including a second cam surface engaged with the first cam surface, (ii) a lower surface having an opening defined therein, and (iii) an inner wall extending upwardly from the opening to define an aperture in the coupler body, the inner wall including a pair of substantially planar surfaces, and
a hinge pin defining the axis of rotation, the hinge pin having an upper end positioned in the aperture of the coupler body, the upper end including a pair of substantially planar surfaces engaged with the pair of substantially planar surfaces of the coupler body to prevent rotation of the coupler body about the axis of rotation.

17. The domestic refrigerator of claim 16, wherein:
the inner wall of the coupler body extends upwardly from the opening to an inner surface, the inner wall and the inner surface defining the aperture in the coupler body, and
the coupler body includes a central shaft that extends downwardly from the inner surface, the central shaft having a lower end positioned in a passageway defined in the hinge pin.

18. The domestic refrigerator of claim 17, further comprising an adjustment mechanism configured to move the door vertically between a first position and a second position relative to the cabinet.

19. The domestic refrigerator of claim 18, further comprising a threaded rod positioned in the passageway defined in the hinge pin and engaged with the lower end of the coupler body, the threaded rod being configured to rotate in (i) a first direction to cause upward movement of the door and (ii) a second direction to cause downward movement of the door.
